(19) United States
(12) Patent Application Publication
(10) Pub. No.: US 2013/0051467 A1
(43) Pub. Date: Feb. 28, 2013

(54) HYBRID INTER/INTRA PREDICTION IN VIDEO CODING SYSTEMS

(71) Applicants: Xiaosong Zhou, Campbell, CA (US); Douglas Scott Price, San Jose, CA (US); Hsi-Jung Wu, San Jose, CA (US)

(72) Inventors: Xiaosong Zhou, Campbell, CA (US); Douglas Scott Price, San Jose, CA (US); Hsi-Jung Wu, San Jose, CA (US)

(73) Assignee: APPLE INC., Cupertino, CA (US)

(21) Appl. No.: 13/591,637

(22) Filed: Aug. 22, 2012

Related U.S. Application Data
(60) Provisional application No. 61/529,716, filed on Aug. 31, 2011.

(51) Int. Cl. H04N 7/34

(52) U.S. Cl. 375/240.13; 375/240.16; 375/E07.243; 375/E07.265

(57) ABSTRACT

Embodiments of the present invention provide techniques for efficiently coding/decoding video data during circumstances where no single coding mode is appropriate. A coder may predict content of an input pixel block according to a prediction technique for intra-coding and obtain a first predicted pixel block therefrom. The coder may predict content of the input pixel block according to a prediction technique for inter-coding and obtain a second predicted pixel block therefrom. The coder may average the first and second predicted pixel blocks by weighted averaging. The weight of the first predicted pixel block may be inversely proportional to the weight of the second predicted pixel block coding. The coder may predictively code the input pixel block based on a third predicted pixel block obtained by the averaging.

### CROSS REFERENCE TO RELATED APPLICATIONS

This application claims the benefit of priority to previously filed U.S. provisional patent application Ser. No. 61/529,716 filed Aug. 31, 2011, entitled HYBRID INTER/INTRA PREDICTION IN VIDEO CODING SYSTEMS. That provisional application is hereby incorporated by reference in its entirety.

### BACKGROUND

Aspects of the present invention relate generally to the field of video processing, and more specifically to a predictive video coding system.

In video coding systems, an coder may code a source video sequence into a coded representation that has a smaller bit rate than does the source video and, thereby achieve data compression. A decoder may then invert the coding processes performed by the coder to reconstruct the source video for display or storage.

A variety of different techniques are available to code frames from a video sequence. Intra-coding (also called “I” coding) includes techniques for coding frame content without reference to any other frame. Pixel blocks within an intra-coded frame may be predicted from content of other pixel blocks within the same frame. Inter-coding involves techniques for coding frame content from content of other frames. Pixel blocks within an inter-coded frame may be predicted from content of pixel blocks from one or perhaps two other reference frames (called “P” and “B” coding respectively). Select pixel blocks of an inter-coded frame may be coded on an I-coding basis if P-coding and B-coding techniques do not work well but this is an exception. In the case of inter-coding, coded video data identifies the reference frame(s) and provides motion vectors that identify locations within the reference frames from which predicted pixel blocks may be extracted.

I, P and B coding modes can prove to be limiting in some circumstances. It may occur that no single coding mode is appropriate for certain image content within pixel blocks. Therefore, the inventors perceive a need in the art for a coding system that can merge aspects of intra coding and inter coding in a hybrid fashion.

### BRIEF DESCRIPTION OF THE DRAWINGS

FIG. 1 is a simplified block diagram of a video coding system according to an embodiment of the present invention.

FIG. 2 is a functional block diagram illustrating coding processes for hybrid coding of pixel blocks, according to an embodiment of the present invention.

FIG. 3 is a simplified block diagram of a video coder according to an embodiment of the present invention.

FIG. 4 is a simplified block diagram of a video decoder according to an embodiment of the present invention.

FIG. 5 is a simplified flow diagram illustrating a hybrid inter/intra method for coding a pixel block from a frame according to an embodiment of the present invention.

FIG. 6 is a simplified flow diagram illustrating a method for predictively coding an input pixel block according to an embodiment of the present invention.

FIG. 7 illustrates operation of the method of FIG. 6 in the context of exemplary pixel block data according to an embodiment of the present invention.

### DETAILED DESCRIPTION

Embodiments of the present invention provide techniques for efficiently coding/decoding video data during circumstances where no single coding mode is appropriate. According to the embodiments, a coder may predict content of an input pixel block according to a prediction technique for intra-coding and obtain a first predicted pixel block therefrom. The coder may predict content of the input pixel block according to a prediction technique for inter-coding and obtain a second predicted pixel block therefrom. The coder may average the first and second predicted pixel blocks by weighted averaging. The weight of the first predicted pixel block may be inversely proportional to the weight of the second predicted pixel block coding. The coder may predictively code the input pixel block based on a third predicted pixel block obtained by the averaging.

In another embodiment, a coder may predict content of an input pixel block according to a prediction technique for inter-coding and obtaining a predicted pixel block therefrom. The coder may reconstruct a previously coded pixel block neighboring the input pixel block. The coder may measure discontinuities along edge(s) of the neighboring pixel block and the inter predicted pixel block. If the discontinuities exceed a threshold, the coder may spatially filter an edge of the predicted pixel block using data of the neighboring pixel block and code the input pixel block with reference to the filtered inter predicted pixel block. The threshold may adjusted based on different variables, including whether or not the neighboring pixel blocks were coded using intra, inter, and/or hybrid prediction.

In an embodiment, a decoder may identify a first intra-predicted pixel block corresponding to an input coded pixel block. The decoder may identify a second inter-predicted pixel block corresponding to the input coded pixel block. The decoder may obtain a third pixel block by averaging the first and second pixel blocks by weighted averaging. The weight of the first pixel block may be inversely proportional to the weight of the second pixel block coding.

In a further embodiment, a decoder may identify an inter predicted pixel block corresponding to an input coded pixel block. The decoder may identify a previously decoded pixel block neighboring the input coded pixel block. The decoder may measuring discontinuities along edge(s) of the neighboring pixel block and the inter predicted pixel block. If the discontinuities exceed a threshold, the decoder may spatially filtering an edge of the predicted pixel block using data of the neighboring pixel block and decode the input coded pixel block with reference to the filtered inter predicted pixel block.

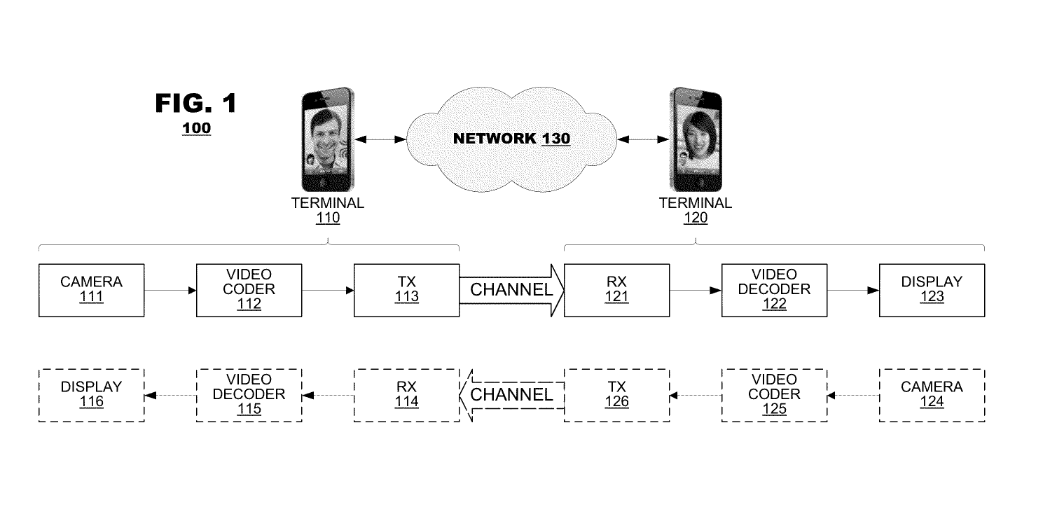

FIG. 1 is a simplified block diagram of a video coding system 100 according to an embodiment of the present invention. The system 100 may include a plurality of terminals 110, 120 interconnected via a network 130. The terminals 110, 120 each may capture video data at a local location and code the video data for transmission to the other terminal via the network 130. Each terminal 110, 120 may receive the coded video data of the other terminal from the network 130, reconstruct the coded data and display video data recovered therefrom.

In FIG. 1, the terminals 110, 120 are illustrated as smart phones but the principles of the present invention are not so limited. Embodiments of the present invention find application with personal computers (both desktop and laptop computers), tablet computers, handheld computing devices, computer servers, media players and/or dedicated video conferencing equipment.

The network 130 represents any number of networks that convey coded video data between the terminals 110, 120, including for example wireline and/or wireless communication networks. The communication network 130 may exchange data in circuit-switched or packet-switched channels. Representative networks include telecommunications networks, local area networks, wide area networks and/or the Internet. For the purposes of the present discussion, the architecture and topology of the network 130 are immaterial to the operation of the present invention unless explained herein below.

The terminal 110 may include a camera 111, a video coder 112, and a transmitter 113. The camera 111 may capture video at a local location for coding and delivery to the other terminal 120. The video coder 112 may code video from the camera 111. Coded video is typically smaller than the source video (they consume fewer bits). The transmitter 113 may build a channel stream from the coded video data and other data to be transmitted (coded audio, control information, etc.) and may format the channel stream for delivery over the network 130.

During operation, the video coder 112 may select coding modes for the various frames of the input video sequences. Typically, each frame is parsed into a plurality of regular arrays of pixel data, called “pixel blocks” herein. Pixel blocks typically are square or rectangular arrays of pixel data (e.g., 16×16 blocks of pixels, 8×8 blocks of pixel, 4×16 blocks of pixels, etc.). The video coder 112 may assign different coding modes—intra-coding, inter-coding and the hybrid coding modes discussed herein—to different pixel blocks within each frame. Oftentimes, a frame type (I-frame, P-frame or B-frame) is assigned to a frame before coding mode selections are selected for pixel blocks; such frame type assignments may constrain coding mode selections for pixel blocks within individual frames.

The terminal 120 may include a receiver 121, a video decoder 122, and a display 123. The receiver 121 may receive channel stream data from the other terminal 110 and may parse the channel stream into coded video streams, audio streams, control data streams, etc. The video decoder 122 may invert coding processes applied by the counterpart video coder 112 and generate a reconstructed video sequence therefrom. The display 123 may display the reconstructed video sequences at the terminal 120.

In an embodiment, to support bidirectional communication, the terminal 120 may include its own functional blocks—a camera 124, a video coder 125, and a transmitter 126—to capture, code, and transmit video data to the terminal 110. Similarly, the terminal 110 may include its own functional blocks—a receiver 114, a video decoder 115, and a display 116—to receive, decode, and display video data received from the terminal 120.

During operation, the video coders 112, 125 may operate on independently generated video streams and make their coding decisions independently of each other. Accordingly, coding decisions effected by one video coder 112 need not, and oftentimes will not, be made at the other video coder 125.

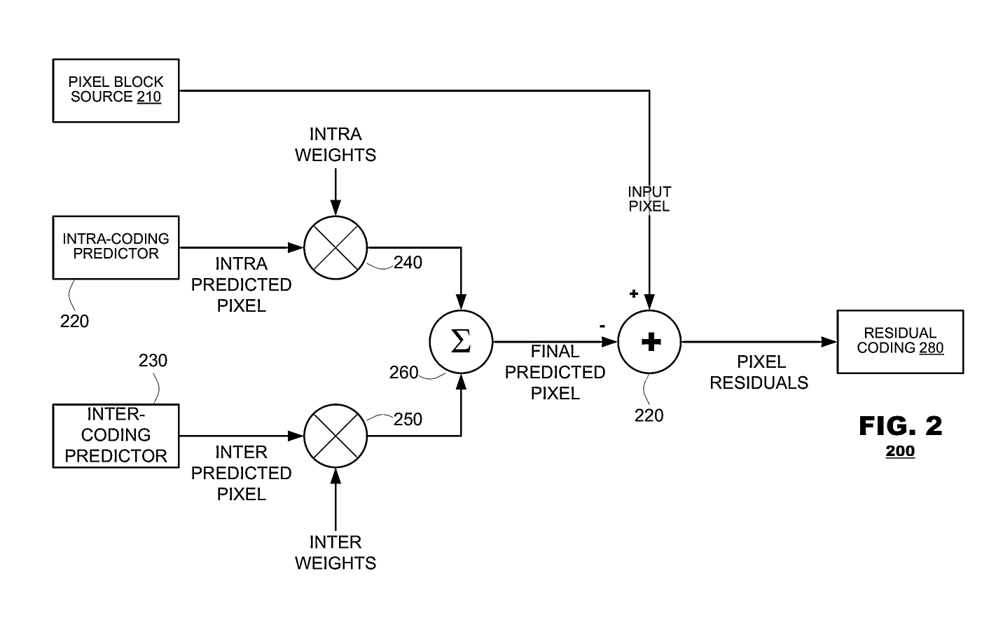

FIG. 2 is a functional block diagram illustrating coding processes for a hybrid coder 200, according to an embodiment of the present invention. Hybrid coding may predict data for an input pixel block using techniques of both intra-coding and inter-coding. The coder 200 may receive input pixel blocks from a pixel block source 210. An intra-coding predictor 220 may predict an intra-coded pixel block for an input pixel block. An inter-coding predictor 230 may predict an inter-coded pixel block for the input pixel block. Scaling units 240 and 250 may scale values of the intra-predicted pixel block and inter-predicted pixel block respectively according to externally-provided weight values. Specifically, the scaling units 240 and 250 may scale each pixel within the respective predicted pixel blocks by the weight values. An adder 260 may add scaled pixel values from the scalars 240 and 250. The adder 260 may generate a final predicted pixel block for use in coding the input pixel block. A subtractor 270 may subtract, on pixel-by-pixel basis, values of the predicted pixel block from values of the input pixel block. The subtractor 270 may generate a pixel block of residual values. A residual coding unit 280 may code residual data as necessary.

In an embodiment, the scaling units 240, 250 and adder 260 may achieve weighted averaging if the scalar weights sum to 1. As a result, communication of one matrix impliedly communicates content of the other matrix because weightᵢₙₜᵣₐ(i, j)=1−weightᵢₙₜₑᵣ(i, j) for all i, j. In another embodiment, weight matrices may be set to have binary values (0 or 1) and may be set to be inversions of each other (again, weightᵢₙₜᵣₐ(i, j)=1−weightᵢₙₜₑᵣ(i, j) for all i, j). Here, the weight matrices may act as masks which pass data of the respective predicted block entirely at pixel locations where the weight value is 1 but block any contribution of the predicted pixel block at pixel locations where the weight value is 0. This allows a coder to apply intra coding at selected sub-portions of a pixel block and inter-coding at other selected sub-portions of the pixel block.

In order to decode a hybrid coded pixel block, the intra weights and inter weights should be known to the video decoder to allow it to mimic coding operations performed by the video coder. Thus, the coder and decoder may operate according to a communication protocol that either expressly communicates weight information from the video coder to the video decoder or impliedly communicates the information.

There are many techniques by which a coder 200 can expressly communicate weight information to a decoder. In an example embodiment, the coder 200 may select a single intra weight and a single inter weight to be applied equally to all pixels of the respective predicted pixel block and may communicate the weight values to the video decoder in designated fields of the channel stream. In another embodiment, the coder 200 may select a matrix of intra weight values and a matrix of inter weight values, one for each pixel of the respective predicted pixel block. The video coder 200 may communicate each weight matrix to the video decoder in designated fields of the channel stream. In an example embodiment, the video coder and video decoder may operate according to a codebook of predefined weight matrices. During coding, a video coder may select weight matrices to be used for coding an input pixel block and may communicate index numbers of the matrices to the video decoder in designated fields of the channel stream. In another embodiment, a coder 200 may communicate weight values expressly.

Similarly, there are many techniques by which weight information may be impliedly signaled to a decoder. In an example embodiment, the coder 200 and decoder (not shown) may operate according to a code book of predefined weight matrices. During coding, selection of weight matrices may be derived from other coding operations performed by the coder 200, such as selection of prediction directions for intra-coding. Selections of prediction directions are made by examination of pixel blocks coded before the input pixel block of interest; the previously-coded pixel block will be available at the decoder prior to receipt of coded video data representing the input pixel block. The coder 200 and decoder both may derive a weight matrix to be used based on selection of prediction directions. In a further embodiment, a weight matrix used for one pixel block may be replicated for another. For example, if a pixel block is inter-coded with reference to a pixel block of a designated reference frame, a coder and decoder may replicate a weight matrix used for decoding of the designated reference frame for decoding the input pixel block.

Communication of weights may also include a blend of express and implied signaling. In an example embodiment, a video coder and decoder may operate according to a common codebook of weight matrices, which are indexed in part by coding parameters supplied for other purposes (e.g., quantization parameters, motion vectors, reference frame IDs, etc.) and in part by data provided in designated fields of the channel stream.

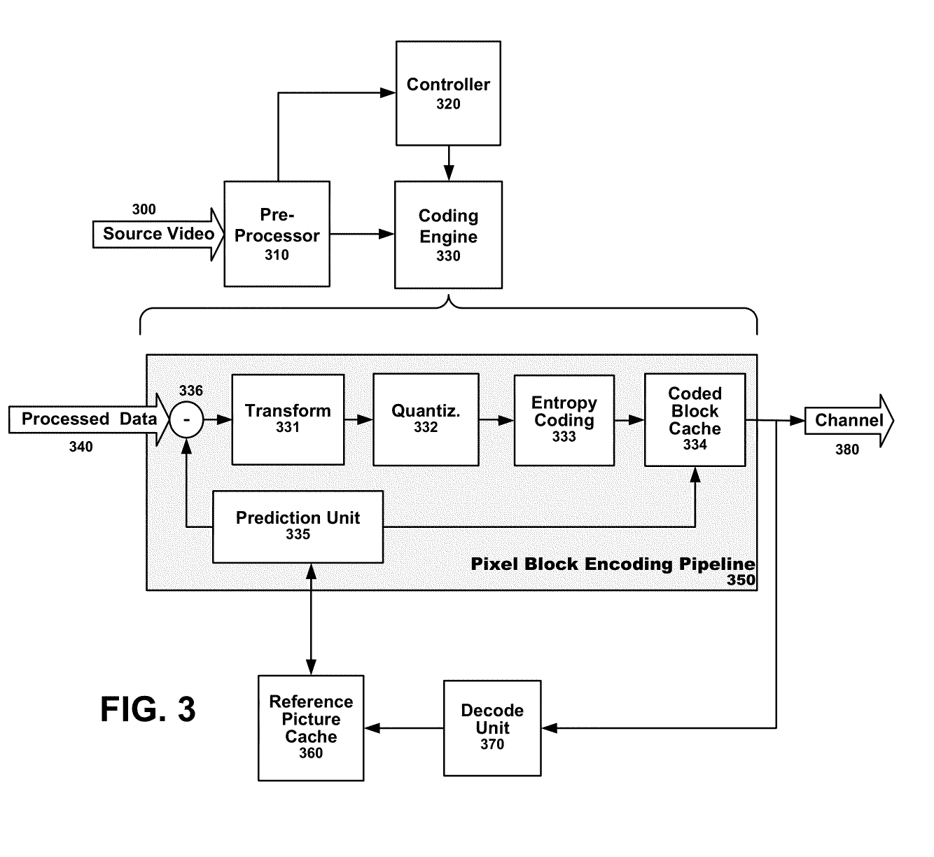

FIG. 3 is a simplified block diagram of a video coder 300 according to an embodiment of the present invention. The coder 300 may include a pre-processor 310, a controller 320, a coding engine 330, a reference picture cache 360 and a local decoding unit 370. The pre-processor 310 may receive the input video data from the video source 300, such as a camera or storage device, may separate the video data into frames, and may prepare the frames for coding. The controller 320 may receive the processed frames from the pre-processor 310 and may determine appropriate coding modes for the processed frames. For each pixel block in a frame, the controller 320 may select a coding mode to be utilized by the coding engine 330 and may control operation of the coding engine 330 to implement each coding mode by setting operational parameters. The coding engine 330 may receive video output from the pre-processor 310 and may generate compressed video in accordance with the coding mode parameters received from the controller 320. The decoding unit 370 may reconstruct the compressed video by parsing the coded video data to recover the original source video data. The reference frame cache 360 may store the reconstructed frame data representing sources of prediction for later-received frames input to the video coding system.

The coding engine 330 may include a pixel block encoding pipeline 350 that may include a prediction unit 335, a subtractor 336, a transform unit 331, a quantizer unit 332, and an entropy coder 333. The prediction unit 335 may select a coding mode to be applied to an input pixel block presented to the pipeline 350 and may generate predicted pixel block data therefor. The subtractor 336 may generate data representing a difference between the input pixel block and the predicted pixel block provided by the prediction unit. The subtractor 336 may operate on a pixel-by-pixel basis, developing residuals at each pixel position over the pixel block. The transform unit 331 may convert the source pixel block data to an array of transform coefficients, such as by a discrete cosine transform (DCT) process or a wavelet transform. The quantizer unit 332 may quantize (divide) the transform coefficients obtained from the transform unit 331 by a quantization parameter Qp. The entropy coder 333 may code quantized coefficient data by run-value coding, run-length coding or the like. Data from the entropy coder 333 may be output to a channel 380 as coded video data of the pixel block. The transform unit 331, quantizer 332, and entropy coder 333 represent processes performed for residual coding 280 as indicated in FIG. 2.

The prediction unit 335 may select between I, P, B and hybrid coding modes for coding of the input pixel block. Typically, the mode selection involves estimating which mode will minimize residual values for further coding. For I coding, the prediction unit 335 may supply reconstructed pixel block data of a pixel block from the same frame as the input pixel block as the predicted pixel block. For P and B coding, the prediction unit 335 may supply reconstructed data selected from a single reference frame or averaged from a pair of reference frames as the predicted pixel block. The prediction unit 335 may generate metadata identifying reference frame(s) selected for prediction and motion vectors identifying locations within the reference frames from which the predicted pixel blocks are derived. For hybrid coding, the prediction unit 335 may select weights and may supply a final prediction pixel block derived as shown in FIG. 2 above. The prediction unit 335 may store weight codebooks (not shown) as necessary. The intra-prediction block may be generated as discussed above for I coding and the inter-prediction block may be generated as discussed above for P and B coding. Metadata generated for the intra-coding and inter-coding techniques also may be supplied when hybrid coding is selected.

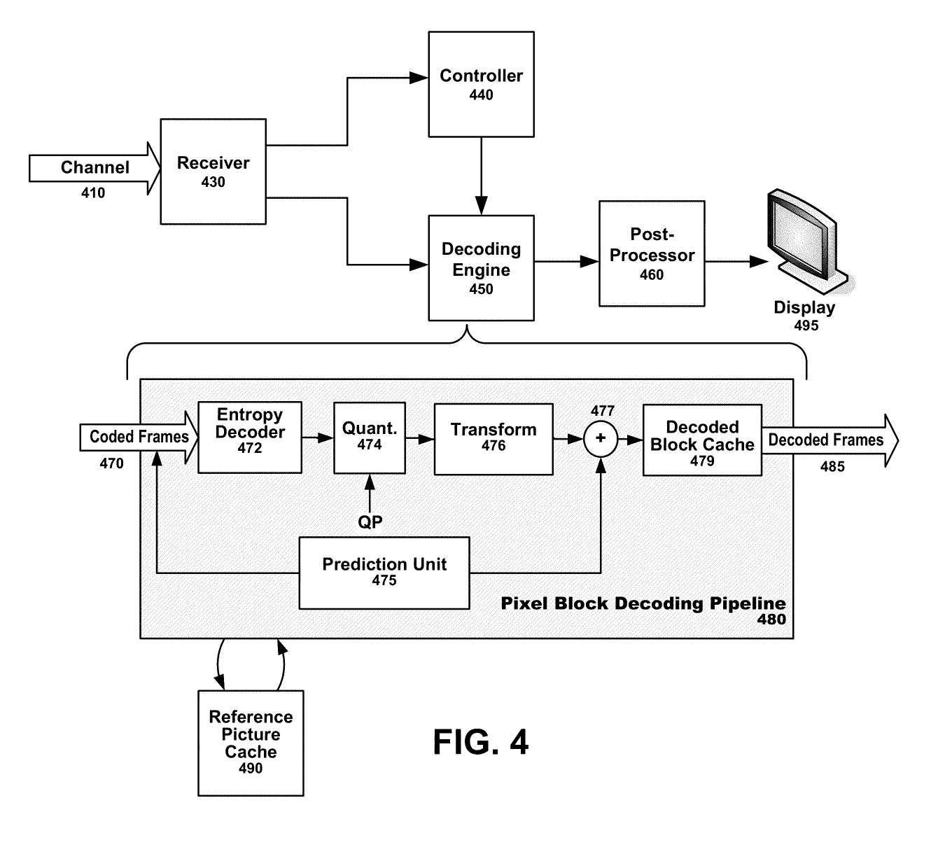

FIG. 4 is a simplified block diagram of a video decoder 400 according to an embodiment of the present invention. The decoder may include a receiver 430, a controller 440, a decoding engine 450, a post-processor 460, and a reference picture cache 490. The receiver 430 may receive coded video data from the channel 410 and may pass the coded data to the decoding engine 450. The controller 440 may manage the operation of the decoder. The decoding engine 450 may receive coded/compressed video signals from the receiver 430 and instructions from the controller 440 and may decode the coded video data based on prediction modes identified therein. The post-processor 460 may apply further processing operations to the reconstructed video data prior to display. This may include further filtering, de-interlacing, or scaling the recovered video frames. The reference picture cache 490 may store reconstructed reference frames that may be used by the decoding engine during decompression to recover P-frames, B-frames, I-frames, or hybrid frames.

The decoding engine 450 may include pixel block decoding pipeline 480 that may include an entropy decoder 472, a quantization unit 474, a transform unit 476, a prediction unit 475, and an adder 477. The entropy decoder 472 may decode the coded frames by run-value or run-length or similar coding for decompression to recover the truncated transform coefficients for each coded frame. The quantization unit 474 may multiply the transform coefficients by a quantization parameter to recover the coefficient values. The transform unit 476 may convert the array of coefficients to frame or pixel block data, for example, by a discrete cosine transform (DCT) process or wavelet process. The prediction unit 475 may select a decoding mode to be applied to an input coded pixel block as directed by metadata from channel 410 and may generate decoded predicted pixel block data therefor. The adder 477 may generate data representing a sum between the residual pixel block and the predicted pixel block provided by the prediction unit 475. The adder 477 may operate on a pixel-by-pixel basis.

The prediction unit 475 may replicate operations performed by the prediction unit of the coder (FIG. 3). For I decoding, the prediction unit 475 may utilize decoded pixel block data of a pixel block from the same frame as the input pixel block as the predicted pixel block. For P and B decoding, the prediction unit 475 may utilize reconstructed data selected from a single reference frame or averaged from a pair of reference frames as the predicted pixel block. The prediction unit 475 may utilize metadata supplied by the coder, identifying reference frame(s) selected for prediction and motion vectors identifying locations within the reference frames from which the predicted pixel blocks are derived. For hybrid coding, the prediction unit 475 may apply weights as directed by metadata from channel 410 and may supply a final prediction pixel block derived as shown in FIG. 2 above. The prediction unit 475 may store codebooks (not shown) as necessary. The intra-prediction block may be generated as discussed above for I coding and the inter-prediction block may be generated as discussed above for P and B coding. Metadata generated for the intra-coding and inter-coding techniques also may be supplied when hybrid coding is selected.

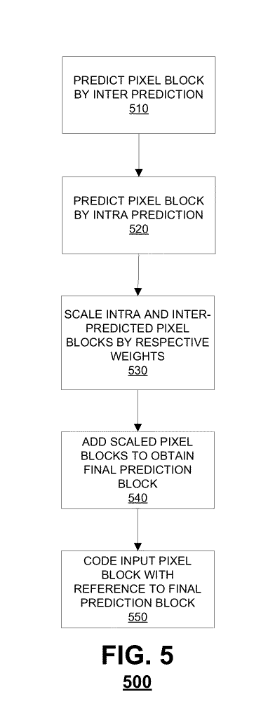

FIG. 5 is a simplified flow diagram illustrating a hybrid inter/intra method 500 for coding a pixel block from a frame according to an embodiment of the present invention. The method 500 may predict a pixel block for the input pixel block by inter prediction (box 510). The method 500 may predict a pixel block for the input pixel block by intra prediction (box 520). The method 500 may scale values of the intra-predicted pixel block and inter-predicted pixel block according to respective weight values (box 530). The method 500 may add the scaled pixel blocks together, generating a final predicted pixel block (box 540). The method 500 may code the input pixel block using the final predicted pixel block as a prediction reference (box 550). Thereafter the method 500 may cause the coded pixel block to be transmitted to a decoder along with any metadata to be communicated by express signaling.

The inter-coding predictor and intra-coding predictor (boxes 510 and 520 respectively) may use any of a number of different prediction processes to generate a predicted pixel block, including those specified in ITU-T's H.264 specification.

In an embodiment, one or more weighted pixel blocks may be combined to generate the final predicted pixel block. In an embodiment intra pixel block(s) may be combined with inter pixel block(s). In an embodiment, intra pixel block(s) may be combined with other intra pixel block(s). In a further embodiment, inter pixel block(s) may be combined with other inter pixel block(s). Specifically, anywhere from 1 to N (where N is a positive integer) pixel blocks may be combined to generate a final predicted pixel block. For example, it may be possible combine two intra and one inter pixel blocks, two inter and one intra pixel blocks, or 5 intra pixel blocks, etc.

In an embodiment, method 500 may operate on a more granular level such as a pixel level within a pixel block. Thus, method 500 may be performed within a single pixel block. This allows for utilization of special pixel weightings that wouldn't be possible with standard prediction modes. For example, in a new vertical-intra type mode, each pixel row going downward in a pixel block may use a different scaling factor to weight the top pixel row used for prediction.

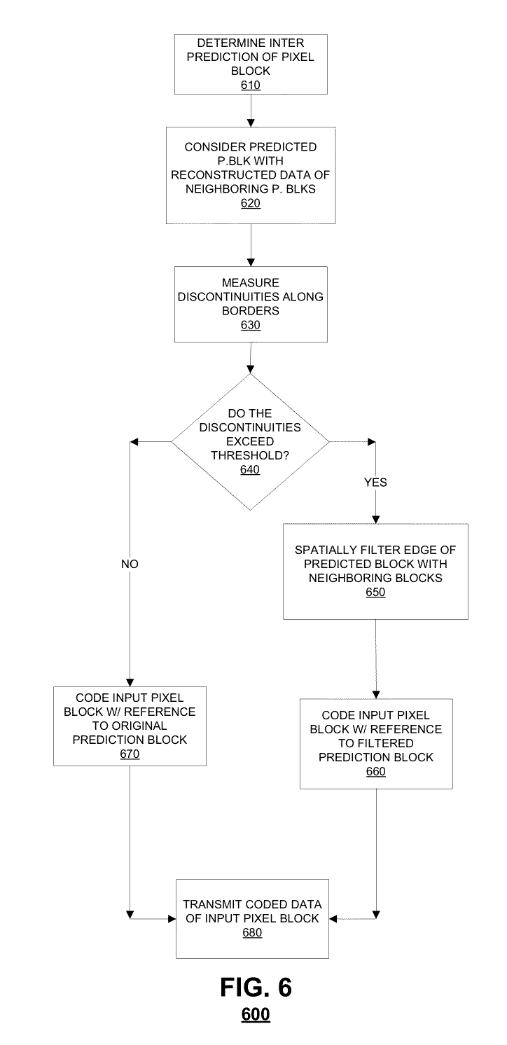

FIG. 6 is a simplified flow diagram illustrating a method 600 for predictively coding an input pixel block according to an embodiment of the present invention. The method 600 may include spatially filtering predicted pixel block data based on previously-coded data of neighboring pixel blocks. The method 600 may predict a pixel block for the input pixel block using inter-coding prediction techniques (box 610). The method 600 may consider the predicted pixel block with reference to reconstructed data of neighboring pixel blocks that have been coded previously (box 620). The method may measure discontinuities along borders of the predicted pixel block and the neighboring pixel blocks and determine if discontinuities in image data at the boundaries exceed a predetermined discontinuity threshold (boxes 630-640). If the discontinuities exceed the discontinuity threshold, the method 600 may apply a spatial filter to the predicted pixel block at locations corresponding to the pixel block's boundaries (box 650). Thereafter, the method 600 may code the input pixel block using the filtered prediction block as a prediction reference (box 660). If the discontinuities do not exceed the discontinuity threshold, the method 600 may code the input pixel block with respect to the prediction block generated at box 610 (box 670). The method 600 may then transmit the final coded block and a residual block (box 680).

The discontinuity threshold may adjusted based on different variables, including whether or not the neighboring pixel blocks were coded using intra, inter, and/or hybrid prediction.

To generate the residual pixel block, a subtractor may subtract on a pixel-by-pixel basis, values of the predicted pixel block from values of the input pixel block. Further coding processes may be applied to the residual pixel block prior to transmitting the residual pixel block.

In an embodiment, when coding an input pixel block, the operations of boxes 620-640 may be performed for each neighboring pixel block that was coded prior to coding of the input pixel block. In such a system, when coders and decoders process data of the current input block, reconstructed data of each of the previously-coded neighboring blocks will be available for consideration. In many systems, pixel blocks may be coded in raster scan order, sequentially coding each pixel block according to its position left-to-right within a row, advancing to the next row and coding each pixel block within that row. In this type of system, reconstructed data of the pixel blocks above the current input pixel block and to the left of the input pixel block should be available. Therefore, the operations of boxes 620-660 likely will be performed on the top boundary and left edge boundary of the input pixel block. Other systems may code pixel blocks according to different coding orders. In this case, the operations of 620-660 will be performed on the pixel block edges which happen to correspond to boundaries between the current input pixel block and previously-coded neighboring pixel blocks.

Configuration of the spatial filter may vary during operation. During operation, a coder may select a filter configuration that minimizes prediction errors for coding and may transmit data identifying the configuration selected. In one embodiment, a common filter configuration may be used for all edges of the input pixel block. In another embodiment, different filter configurations may be used for different edges (e.g., top, left) of the predicted pixel block. In a further embodiment, different filter configurations may be used for different pixel positions along the edge of the predicted pixel block.

The configurations of the spatial filters may vary based on the width of a filter window and weights applied to each position within the filter window. Configurations of the filtering operation may also vary in terms of the number of pixels filtered on each edge of the pixel block. In one embodiment, filtering operations may be performed only on the pixel positions bordering the edge of each pixel block. In other embodiments, filtering operations also may be performed on interior positions of the pixel block, for example, 2^{nd} and 3^{rd} pixel positions from the edges of the predicted pixel blocks.

As with the communication of weights between the coder and the decoder discussed above, communication of the filter configurations may occur via express, implied, or a combination of both express and implied signaling.

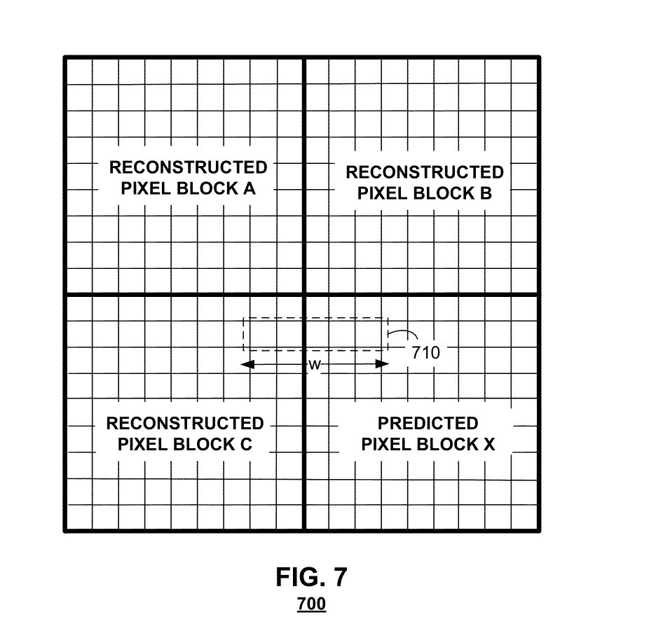

FIG. 7 illustrates operation of the method of FIG. 6 in the context of exemplary pixel block data according to an embodiment of the present invention. The method 600 is operating on an input pixel block (not shown) to be located at the position of block X. Block X as shown represents a predicted pixel block that is obtained through inter-coding prediction. Blocks A-C represent data of previously coded pixel blocks. Window 710 represents a spatial filter to be applied at a left edge position of pixel block X. The filtering operation may generate a weighted average of pixel block values at pixel positions within the filter window W (shown in the FIG. 7 as five pixels wide). A pixel value at the left edge pixel position may be replaced by the value generated from the weighted average. It is expected that, after filtering is applied, any discontinuities observed in boxes 630-640 (FIG. 6) will be reduced. Transitions between the reconstructed pixel blocks A-C and the predicted pixel block X should be smoother, which in turn should reduce any discontinuities that would arise with the input pixel block as it is coded with reference to the predicted pixel block.

In an embodiment, the decoder will generate the reconstructed pixel blocks A-C when it decodes coded video data of those frames. The reconstructed data of pixel blocks A-C, therefore, is available to the decoder when it decodes coded video data of pixel block X. A coder also may generate the reconstructed pixel blocks A-C after it codes them. Thus, the coder may generate a local copy of the reconstructed pixel blocks A-C just as the decoder will generate them.

Although many of the examples in the foregoing discussion illustrate coding operations performed on a pixel block level, in other embodiments, the same operations may be performed on a more granular level such as a pixel level. In particular, different pixels within a pixel block may be assigned different weightings. For example, vertical intra prediction may be used in an inter-intra hybrid prediction case. The pixels closer to the top of a predicted pixel block may be assigned a higher intra weight than the pixels below. Therefore, from top to bottom, the pixels of the predicted block may be assigned a progressively higher inter weighting and a progressively lower intra weighting. In an embodiment, communication of pixel weights may be explicit, implied, or a blend of express and implied signaling as explained above.

In an embodiment, similar to the techniques discussed above pertaining to inter/intra hybrid coding, multiple intra coding modes may be combined to produce a hybrid intra/intra coding mode. For example, a combination of vertical and planar intra prediction may adjust the weight of a pixel based on the position of the pixel.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 1 illustrates the components of video coders and video decoders as separate units, in one or more embodiments, some or all of them may be integrated and they need not be separate units. Such implementation details are immaterial to the operation of the present invention unless otherwise noted above.

Further, the figures illustrated herein have provided only so much detail as necessary to present the subject matter of the present invention. In practice, video coders typically will include functional units in addition to those described herein, including audio processing systems, buffers to store data throughout the coding pipelines as illustrated and communication transceivers to manage communication with the communication network and a counterpart decoder device. Such elements have been omitted from the foregoing discussion for clarity.

While the invention has been described in detail above with reference to some embodiments, variations within the scope and spirit of the invention will be apparent to those of ordinary skill in the art. Thus, the invention should be considered as limited only by the scope of the appended claims.

What is claimed is:

1. A video coding method, comprising:
predicting content of an input pixel block according to a prediction technique for intra-coding and obtaining a first predicted pixel block therefrom;
predicting content of the input pixel block according to a prediction technique for inter-coding and obtaining a second predicted pixel block therefrom;
averaging the first and second predicted pixel blocks by weighted averaging, wherein a weight of the first predicted pixel block is inversely proportional to a weight of the second predicted pixel block coding; and
predictively coding the input pixel block based on a third predicted pixel block obtained by the averaging.

2. The method of claim 1, wherein
the input pixel block comprises a spatial array of pixel values, and
the weights of the first and second pixel blocks vary on a pixel-by-pixel basis.

3. The method of claim 1, wherein
the input pixel block comprises a spatial array of pixel values, and
the weights of the first and second pixel blocks are uniform across all pixels.

4. The method of claim 1, wherein the weights of the first and second pixel blocks are derived from a predetermined codebook.

5. The method of claim 1, wherein weights of the first and second pixel block are derived from coding decisions applied to the input pixel block.

6. The method of claim 1, wherein weights of the first and second pixel block are derived from coding decisions applied to a previously-coded input pixel block.

7. The method of claim 1, further comprising:
transmitting the weights of the first pixel block and the second pixel block to a decoder.

8. A video coding method comprising:
predicting content of an input pixel block according to a prediction technique for inter-coding and obtaining a predicted pixel block therefrom;
reconstructing a previously coded pixel block neighboring the input pixel block;
measuring discontinuities along edge(s) of the neighboring pixel block and the inter predicted pixel block;
when the discontinuities exceed a threshold, spatially filtering an edge of the predicted pixel block using data of the neighboring pixel block; and
coding the input pixel block with reference to the filtered inter predicted pixel block.

9. The method of claim 8, wherein the edge is spatially filtered on a varying pixel-by-pixel basis.

10. The method of claim 8, wherein pixels of the edge are spatially filtered uniformly.

11. The method of claim 8, wherein filter configuration(s) used to spatially filter the edge is derived from a width of a filter window.

12. The method of claim 8, further comprising:
communicating filter configuration(s) to a decoder.

13. The method of claim 12, wherein the communication is at least one of express communication and implied communication.

14. A decoding method comprising:
identifying a first intra-predicted pixel block corresponding to an input coded pixel block;
identifying a second inter-predicted pixel block corresponding to the input coded pixel block;
obtaining a third pixel block by averaging the first and second pixel blocks by weighted averaging, wherein a weight of the first pixel block is inversely proportional to a weight of the second pixel block coding; and
decoding data of the input coded pixel block by predictive decoding techniques using the third pixel block as a basis of prediction.

15. The method of claim 14, wherein
the input coded pixel block comprises a spatial array of pixel values, and
the weights of the first and second pixel blocks vary on a pixel-by-pixel basis.

16. The method of claim 14, wherein
the input coded pixel block comprises a spatial array of pixel values, and
the weights of the first and second pixel blocks are uniform across all pixels.

17. The method of claim 14, wherein the weights of the first and second pixel blocks are derived from a predetermined codebook.

18. The method of claim 14, further comprising obtaining the weights of the first pixel block and the second pixel block from a coder.

19. A decoding method comprising:
identifying an inter predicted pixel block corresponding to an input coded pixel block;
identifying a previously decoded pixel block neighboring the input coded pixel block;
measuring discontinuities along edge(s) of the neighboring pixel block and the inter predicted pixel block;
when the discontinuities exceed a threshold, spatially filtering an edge of the predicted pixel block using data of the neighboring pixel block; and
decoding the input coded pixel block with reference to the filtered inter predicted pixel block.

20. The method of claim 19, wherein the edge is spatially filtered on a varying pixel-by-pixel basis.

21. The method of claim 19, wherein pixels of the edge are spatially filtered uniformly.

22. The method of claim 19, wherein filter configuration(s) used to spatially filter the edge is derived from a width of a filter window.

23. The method of claim 19, further comprising obtaining filter configuration(s) from a coder.

24. A coding apparatus, comprising:
a prediction unit to predict content of an input pixel block according to a prediction technique for intra-coding and obtain a first predicted pixel block therefrom, and predict content of the input pixel block according to a prediction technique for inter-coding and obtain a second predicted pixel block therefrom;
an adder to average the first and second predicted pixel blocks by weighted averaging, wherein a weight of the first predicted pixel block is inversely proportional to a weight of the second predicted pixel block coding;
a coding engine to predictively code the input pixel block based on a third predicted pixel block obtained by the average of the first and second predicted pixel blocks.

25. The apparatus of claim 24, wherein
the input pixel block comprises a spatial array of pixel values, and
the weights of the first and second pixel blocks vary on a pixel-by-pixel basis.

26. The apparatus of claim 24, wherein
the input pixel block comprises a spatial array of pixel values, and
the weights of the first and second pixel blocks are uniform across all pixels.

27. The apparatus of claim 24, wherein the weights of the first and second pixel blocks are derived from a predetermined codebook.

28. The apparatus of claim 24, wherein weights of the first and second pixel block are derived from coding decisions applied to the input pixel block.

29. The apparatus of claim 24, wherein weights of the first and second pixel block are derived from coding decisions applied to a previously-coded input pixel block.

30. The apparatus of claim 24, further comprising:
a channel to transmit the weights of the first pixel block and the second pixel block to a decoder.

31. A coding apparatus, comprising:
a prediction unit to predict content of an input pixel block according to a prediction technique for inter-coding and obtain a predicted pixel block therefrom;
a decoder to reconstruct a previously coded pixel block neighboring the input pixel block;
a controller to measure discontinuities along edge(s) of the at least one neighboring pixel block and the inter predicted pixel block;
a filtering unit to spatially filter an edge of the predicted pixel block using data of the neighboring pixel block when the discontinuities exceed a threshold; and
a coding engine to code the input pixel block with reference to the filtered inter predicted pixel block.

32. The apparatus of claim 31, wherein the edge is spatially filtered on a varying pixel-by-pixel basis.

33. The apparatus of claim 31, wherein pixels of the edge are spatially filtered uniformly.

34. The apparatus of claim 31, wherein filter configuration(s) used to spatially filter the edge is derived from a width of a filter window.

35. The apparatus of claim 31, further comprising:
a channel to communicate filter configuration(s) to a decoder.

36. The apparatus of claim 35, wherein the communication is at least one of express communication and implied communication.

37. A decoding apparatus, comprising:
a prediction unit to identify a first intra-predicted pixel block corresponding to an input coded pixel block, and identify a second inter-predicted pixel block corresponding to the input coded pixel block;
an adder to average the first and second pixel blocks by weighted averaging and obtain a third pixel block, wherein a weight of the first pixel block is inversely proportional to a weight of the second pixel block coding; and
a decoding engine to decode the input coded pixel block predictively using the third pixel block as a basis of prediction.

38. The apparatus of claim 37, wherein
the input coded pixel block comprises a spatial array of pixel values, and
the weights of the first and second pixel blocks vary on a pixel-by-pixel basis.

39. The apparatus of claim 37, wherein
the input coded pixel block comprises a spatial array of pixel values, and
the weights of the first and second pixel blocks are uniform across all pixels.

40. The apparatus of claim 37, wherein the weights of the first and second pixel blocks are derived from a predetermined codebook.

41. The apparatus of claim 37, further comprising:
a channel to convey the weights of the first pixel block and the second pixel block sent from a coder.

42. A decoding apparatus, comprising:
a prediction unit to identify an inter predicted pixel block corresponding to an input coded pixel block;
a controller to identify a previously decoded pixel block neighboring the input coded pixel block and measure discontinuities along edge(s) of the neighboring pixel block and the inter predicted pixel block;
a filtering unit to spatially filter an edge of the predicted pixel block using data of the neighboring pixel block when the discontinuities exceed a threshold; and
a decoding engine to decode the input coded pixel block with reference to the filtered inter predicted pixel block.

43. The apparatus of claim 42, wherein the edge is spatially filtered on a varying pixel-by-pixel basis.

44. The apparatus of claim 42, wherein pixels of the edge are spatially filtered uniformly.

45. The apparatus of claim 42, wherein filter configuration(s) used to spatially filter the edge is derived from a width of a filter window.

46. The apparatus of claim 42, further comprising:
a channel to convey filter configuration(s) sent by a coder.

47. A storage device storing program instructions that, when executed by a processor, cause the processor to:
predict content of an input pixel block according to a prediction technique for intra-coding and obtain a first predicted pixel block therefrom,
predict content of the input pixel block according to a prediction technique for inter-coding and obtain a second predicted pixel block therefrom,
average the first and second predicted pixel blocks by weighted averaging, wherein a weight of the first predicted pixel block is inversely proportional to a weight of the second predicted pixel block coding;
predictively code the input pixel block based on a third predicted pixel block obtained by the averaging.

48. The storage device of claim 47, wherein
the input pixel block comprises a spatial array of pixel values, and
the weights of the first and second pixel blocks vary on a pixel-by-pixel basis.

49. The storage device of claim 47, wherein
the input pixel block comprises a spatial array of pixel values, and
the weights of the first and second pixel blocks are uniform across all pixels.

50. The storage device of claim 47, wherein the weights of the first and second pixel blocks are derived from a predetermined codebook.

51. The storage device of claim 47, wherein weights of the first and second pixel block are derived from coding decisions applied to the input pixel block.

52. The storage device of claim 47, wherein weights of the first and second pixel block are derived from coding decisions applied to a previously-coded input pixel block.

53. The storage device of claim 47, wherein the program instructions further cause the processor to:
transmit the weights of the first pixel block and the second pixel block to a decoder.

54. A storage device storing program instructions that, when executed by a processor, cause the processor to:
predict content of an input pixel block according to a prediction technique for inter-coding and obtain a predicted pixel block therefrom;
reconstruct a previously coded pixel block neighboring the input pixel block;
measure discontinuities along edge(s) of the at least one neighboring pixel block and the inter predicted pixel block;
when the discontinuities exceed a threshold, spatially filter an edge of the predicted pixel block using data of the neighboring pixel block; and
code the input pixel block with reference to the filtered inter predicted pixel block.

55. A storage device storing program instructions that, when executed by a processor, cause the processor to:
identify a first intra-predicted pixel block corresponding to an input coded pixel block;
identify a second inter-predicted pixel block corresponding to the input coded pixel block;
average the first and second pixel blocks by weighted averaging to obtain a third pixel block, wherein a weight of the first pixel block is inversely proportional to a weight of the second pixel block coding; and
decode data of the input coded pixel block by predictive decoding techniques using the third pixel block as a basis of prediction.

56. A storage device storing program instructions that, when executed by a processor, cause the processor to:
identify an inter predicted pixel block corresponding to an input coded pixel block;
identify a previously decoded pixel block neighboring the input coded pixel block;
measure discontinuities along edge(s) of the neighboring pixel block and the inter predicted pixel block;
when the discontinuities exceed a threshold, spatially filter an edge of the predicted pixel block using data of the neighboring pixel block; and
decode the input coded pixel block with reference to the filtered inter predicted pixel block.
